(19) United States
(12) Patent Application Publication
(10) Pub. No.: US 2014/0029791 A1
(43) Pub. Date: Jan. 30, 2014

(54) LIGHT EMITTING SOURCE DETECTION DEVICE, LIGHT BEAM CONTROL DEVICE AND PROGRAM FOR DETECTING LIGHT EMITTING SOURCE

(71) Applicant: DENSO CORPORATION, Kairya-city (JP)

(72) Inventors: Raise Mori, Obu-shi (JP); Kenji Kato, Kariya-shi (JP)

(21) Appl. No.: 13/922,494

(22) Filed: Jun. 20, 2013

(30) Foreign Application Priority Data
Jul. 25, 2012 (JP) 2012-164975

(51) Int. Cl. G06K 9/00

(52) U.S. Cl. CPC G06K 9/00791
USPC 382/103

(57) ABSTRACT

A processing section as a light emitting source detection device in a light beam control system changes irradiation parameters, one of an irradiation range and a luminance of a light beam of head lamps of an own vehicle. The light beam of the head lamps is irradiated toward a light object corresponding to a light source detected in captured image data. The processing section detects whether or not the luminance of the detected light source is changed after the change of the irradiation parameters, and sets a probability value of the detected light source to a value lower than a probability value of a light source when luminance is not changed even if the irradiation parameters are changed. When the probability value of the detected light source is not less than a predetermined threshold value, the processing section determines that the detected light source is a vehicle light source.

### CROSS-REFERENCE TO RELATED APPLICATION

This application is related to and claims priority from Japanese Patent Application No. 2012-164975 filed on Jul. 25, 2012, the contents of which are hereby incorporated by reference.

### BACKGROUND OF THE INVENTION

1. Field of the invention

The present invention relates to light emitting source detection devices, light beam control devices and programs for quickly detecting light emitting sources such as head lamps of an oncoming vehicle with high accuracy, on a road on which an own vehicle is running on the basis of captured image data.

2. Description of the Related Art

There have been known light emitting source detection device capable of detecting light sources in captured image data and recognizing a light source such as a head lamp of a vehicle on the basis of shapes and colors of the detected light sources in the captured image data. For example, a conventional patent document, Japanese registered patent No. JP 4697101 discloses a structure of such a light emitting source detection device.

However, the conventional light emitting source detection device causes a detection error to recognize a reflector as a light emitting source of a vehicle because a shape and a color of such a reflector are similar to a shape and a color of a head lamp or a tail lamp of a vehicle. The conventional light emitting source detection device further causes a similar detection error to recognize a light emitting source which generates and emits a light as the head lamps of a vehicle.

### SUMMARY

It is therefore desired to provide a light emitting source detection device, a light beam control device and a program for detecting a light emitting source, for example head lamps of a vehicle, which generates and emits a light with high accuracy on the basis of captured image data.

An exemplary embodiment provides a light emitting source detection device for detecting a light emitting source in captured image data. The light emitting source detection device is comprised of an irradiation parameter change section, a luminance change detection section, a probability value setting section and a light emitting source detection section. The irradiation parameter change section changes irradiation parameters to change an irradiation state of a light beam of a light source of an own vehicle such as head lamps toward a light source which is present in front of the light emitting source detection device when the light source is detected in captured image data. The luminance change detection section detects whether or not a luminance of the light source detected in the captured image data is changed when the irradiation parameter is changed. The probability value setting section decreases a probability value of the detected light source when the luminance of the detected light source is changed more than a probability value of the detected light source when the luminance of the detected light source is not changed. The light emitting source detection section determines that the detected light source is a light emitting source as a luminous object which emits light when the probability value of the detected light source is not less than a predetermined threshold value.

Accordingly, the inventors of the present invention have paid attention to the following matters. When the irradiation parameters of the head lamps of the own vehicle are changed, i.e., when the luminance of a light beam of the head lamps of the own vehicle is changed, a luminance change of a luminous object which emits light (for example, the head lamps of an oncoming vehicle) is lower than a luminance change of a non-luminous object such as a reflector which reflects light only, does not generate and emits a light. Further, the light emitting source detection device changes a probability value of the light source detected in the captured image data, which indicates a probability that the detected light source is a luminous object such as a head lamp of a vehicle, on the basis whether or not the luminance of the detected light source is changed to more than the reference value stored in advance in the memory section when the irradiation parameter is changed.

Accordingly, the light emitting source detection device according to the exemplary embodiment having the structure previously described can quickly distinguish a reflector from a luminous object which generates and emits light with high accuracy, where the reflector reflects the light beam transmitted from the head lamps of the own vehicle, and objects such as head lamps of an oncoming vehicle emit light. This makes it possible to detect a light source as a luminous object which emits light in captured image data with high accuracy.

Through the description of the present invention, the technical phrase “toward a light source” indicates that a light source detected in captured image data is present within an irradiation range of a light beam of the head lamps of the own vehicle. In addition, the technical phrase “toward a light source” indicates that a detected light source becomes present within the irradiation range of a light beam of the head lamps when the irradiation range of a light beam of the head lamps is changed even if the light source is outside the captured image data.

Through the description of the present invention, the technical phrase “irradiation state” contains an irradiation range of a light beam of the head lamps of the own vehicle and irradiation parameters such as luminance of head lamps of the own vehicle. It is also possible to use a following structure in order to obtain a physical structure of the light emitting source detection device. That is, the luminance change detection section detects whether or not a luminance change of the detected light source is not less than a reference value when the irradiation parameter is changed. When the detection result indicates that the luminance change of the detected light source is greater than the reference value, the probability value setting section decreases a probability value of the detected light source as compared with a probability value of a detected light source without any change of luminance. This structure makes it possible to detect a light emitting source, which emits light, detected in captured image data with high accuracy.

Still further, it is possible to use programs stored in a memory section in order to realize the functions of the irradiation parameter change section, the luminance change detection section, the probability value setting section and the light emitting source detection section. Further, it is possible to apply the light emitting source detection device to a vehicle light source detection device which detects light sources such as head lamps of other vehicles such as an oncoming vehicle on the same road on which the own vehicle is running.

### BRIEF DESCRIPTION OF THE DRAWINGS

A preferred, non-limiting embodiment of the present invention will be described by way of example with reference to the accompanying drawings, in which:

FIG. 1 is a block diagram showing a light beam control system 1 according to an exemplary embodiment of the present invention comprised of a camera 20, a speed sensor 21, a steering angle sensor 22, a processing section 10 as a light emitting source detection device, and a light beam control section 30 as a light beam control device;

FIG. 2 is a flow chart showing a light emitting source detection process and a light beam control process executed by the processing section 10 and the light beam control section 30 according to the exemplary embodiment of the present invention;

FIG. 3A, FIG. 3B and FIG. 3C are views showing examples of the light beam control executed by the processing section 10 and the light beam control section 30; and

FIG. 4 is a view showing an example of captured image data (one frame) obtained by the camera 20 and processed by the processing section 10 in the light beam control system 1 shown in FIG. 1.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

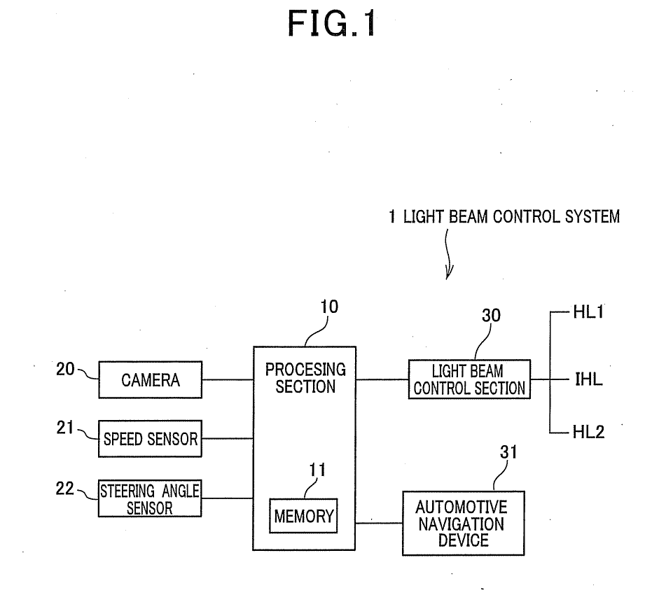

A description will be given of a light beam control system 1 comprised of a light emitting source detection device, a light beam control device and a program for detecting a light emitting source in captured image data according to an exemplary embodiment with reference to FIG. 1 to FIG. 4.

### (Structure)

FIG. 1 is a block diagram showing the light beam control system 1 according to an exemplary embodiment of the present invention. The light beam control system 1 is comprised of a camera 20, a speed sensor 21, a steering angle sensor 22, a processing section 10, a light beam control section 30, head lamps HL1 and HL2, an automotive navigation device 31, and an infrared lamp IHL. The processing section 10 corresponds to the light emitting source detection device, and the light beam control section 30 corresponds to the light beam control device.

The light beam control system 1 shown in FIG. 1 is mounted to various types of vehicles such as passenger vehicles. When one or more vehicles are running around the own vehicle equipped with the light beam control system 1, the light beam control system 1 switches an optical axis of the head lamps HL1, HL2 of the own vehicle to a low beam. In other words, when the light beam of the head lamps of the own vehicle dazzles a driver of an oncoming vehicle, the light beam control system 1 switches the light beam of the head lamps HL1, HL2 to a low beam in order to avoid the driver of the oncoming vehicle from being dazzled.

In more detail, as shown in FIG. 1, the light beam control system 1 is comprised of the processing section 10, the camera 20, the speed sensor 21, the steering angle sensor 22, the light beam control section 30, the automotive navigation system 31, the head lamps HL1 and HL2, and the infrared lamp IHL. The camera 20 is mounted to a vehicle so that the camera 20 scans a front area in front of the own vehicle within a predetermined irradiation area of head lamps HL1 and HL2 of the own vehicle in a forward direction to which the own vehicle moves. That is, the camera 20 is a color camera capable of photographing color image of the front area in the movement direction of the own vehicle. The camera 20 transmits captured image data to the processing section 10.

The speed sensor 21 and the steering angle sensor 22 have a known structure and are used to estimate a movement direction of the own vehicle. The speed sensor 21 and the steering angle sensor 22 transmit detection signals which indicate detection results to the processing section 10.

The processing section 10 detects light sources such as head lamps HL1 and HL2 of vehicles on the basis of the image data (or front image data) and information transmitted from the speed sensor 21, the steering angle sensor 22, etc. The light beam control section 30 adjusts a direction of an optical axis of the head lamps HL1 and HL2 of the own vehicle (namely, adjusts the direction of a light beam of the head lamps HL1 and HL2 of the own vehicle) on the basis of the detection signals transmitted from the processing section 10. In a concrete example, the light beam control section 30 switches the light beam of the head lamps HL1 and HL2 of the own vehicle to a high beam and a low beam. It is possible for the light beam control section 30 to have a structure in which an optical axis of a light beam of the head lamps HL1 and HL2 of the own vehicle is changed to a direction, in which no vehicle is present, for example to a left side (or right side), or a part of the head lamps is closed by a shutter mechanism.

The light beam control section 30 further has a headlight elevation mechanism. When receiving an instruction signal transmitted from the processing section 10, the processing section 10 instructs the light beam control section 30 having the headlight elevation mechanism to adjust the light beam of the head lamps HL1 and HL2 of the own vehicle.

The processing section 10 is comprised of a central processing unit (CPU) and a memory section 11. The memory section 11 is comprised of various types of memories such as a read only memory (ROM) and a random access memory (RAM). The CPU in the processing section 10 reads one or more programs (including a program for detecting light emitting source) stored in the memory section 11. The CPU executes the program stored in the memory section 11 in order to detect light sources such as head lamps of vehicles on the road on which the own vehicle is running. For example, the memory section 11 stores irradiation parameters of light sources such as head lamps and tail lamps other than data of vehicles. The parameters of light sources indicate features of various types of lamps of vehicles, for example a size, a color, a dimension such as a height and a width, a distance between a pair of lamps, a light movement of a lamp, luminance data of each light source such as a luminance, a luminous intensity, an average luminous intensity, a maximum luminous intensity, etc. The CPU in the processing section 10 distinguishes a light source which emits a light such as head lamps, tail lamps of a vehicle from various light sources detected in the captured image, and identifies that the detected lamp is a vehicle lamp by using the parameters stored in the memory section 11.

### (Light Emitting Source Detection Process and Light Beam Control Process)

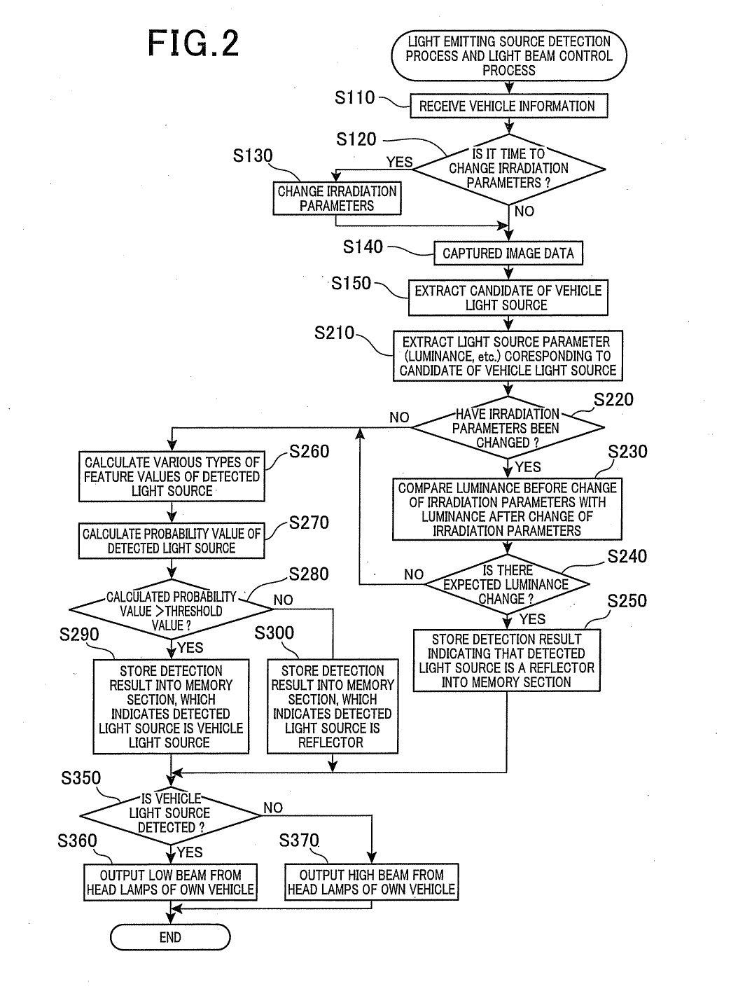

Next, a description will now be given of the light emitting source detection process and the light beam control process with reference to FIG. 2.

FIG. 2 is a flow chart showing, the light emitting source detection process and the light beam control process executed by the processing section 10 and the light beam control section 30 according to the exemplary embodiment.

The light beam control process is started when an electric power of the own vehicle is turned on. The light beam control process is executed repeatedly every predetermined time intervals, every 100 ms, for example. In more detail, in step S110 shown in FIG. 2, the processing section 10 receives vehicle information regarding various type of vehicle data.

The vehicle information include detection results transmitted from the speed sensor 21 and the steering angle sensor 22 of the own vehicle. The processing section 10 uses the vehicle information in order to recognize a shape of a road in which the own vehicle is running. It is also possible for the processing device 10 to receive traffic information including a road shape and condition of the road through the automotive navigation device 31, for example. The operation flow goes to step S120.

In step S120, the processing section 10 detects whether or not it is time to change one or more irradiation parameters of a light beam of the head lamps HL1 and HL2 of the own vehicle. The irradiation parameters indicate an irradiating range or luminous intensity of a light beam of the head lamps HL1 and HL2 of the own vehicle to the light source in the captured image data. In the exemplary embodiment, the processing section 10 uses the irradiation parameters in order to adjust the elevation of the head lamps HL1 and HL2 of the own vehicle.

The processing section 10 adjusts the irradiation parameters when the own vehicle just approaches the beginning of a curved road, the processing section 10 detects a new light source in the captured image data, or a predetermined period of time is elapsed. It is possible for the processing section 10 to use an optional timing at which the irradiation parameters are changed.

When the detection result obtained in step S120 indicates affirmation (“YES” in step S120), i.e., it is time to adjust the irradiation. parameters (“YES” in step S120), the operation flow goes to step S130. In step S130, the processing section 10 adjusts the irradiation parameters.

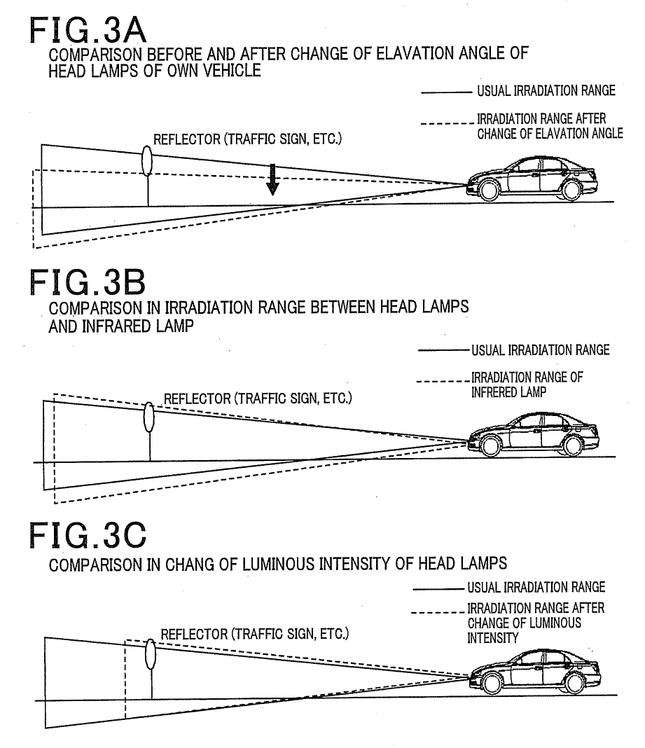

FIG. 3A, FIG. 3B and FIG. 3C are views showing examples of the light beam control executed by the processing section 10 and the light beam control section 30. As shown in FIG. 3A, the processing section 10 instructs the light beam control device 30 to adjust an elevation angle of the head lamps HL1 and HL2 of the own vehicle to a low elevation angle.

This elevation angle, adjusting process limits the irradiation range of the head lamps HL1 and HL2 of the own vehicle so that another vehicle, which is indicated by the light source detected in the captured image, is out of the irradiation range of the light beam of the head lamps HL1 and HL2 of the own vehicle. After the completion of the elevation angle adjusting process in step S130, the operation flow goes to step S140.

On the other hand, when the detection result obtained in step S120 indicates negation (“NO” in step S120), i.e., it is not a time to adjust the irradiation parameters. At this time, the processing section 10 instructs the light beam control section 30 to adjust the light beam of the head lamps HL1 and HL2 of the own vehicle so that the light beam of the head lamps HL1 and HL2 has an upward direction as compared with the direction of the light beam of the head lamps HL1 and HL2 in an usual state, i.e., at a time to adjust the irradiation parameters. The operation flow goes to step S140.

In step S140, the processing section 10 receives captured image data (frames) transmitted from the camera 20. The operation flow goes to step S150. In step S150, the processing section 10 detects the presence of one or more light sources in the captured image data. The light sources include a light emitting source which emits light and a light source which reflects light only, i.e. emits no light. The detected light source is a light source candidate of a vehicle.

In step S150, the processing section 10 detects a light source as a candidate of a light source of a vehicle (or a vehicle light source) in the captured image data. For example, there are various vehicles such as an oncoming vehicle on the road on which the own vehicle is running. That is, the processing section 10 extracts a smallest rectangle area, which includes a whole area of the candidate of the vehicle light source, from the captured image data. A label (which indicates an identified number) is assigned to the extracted rectangle area. The more the size of the detected vehicle light source is increased, the more the area of the extracted rectangle area is increased. The operation flow goes to step S210.

In step S210, the processing section 10 fetches light source parameters such as luminance of a light source (an average luminance and a maximum luminance of a light source) from the memory section 11. Such light source parameters indicate characteristics of a light source. The processing section 10 executes a series of the processes from step S210 to step S300 for every detected light source.

The operation flow goes to step S220. In step S220, the processing section 10 detects whether or not the irradiation parameters have been changed. When the detection result obtained in step S220 indicates negation (“NO” in step S220), i.e., without any change of the irradiation parameters, the operation flow goes to step S260. The process in step S260 will be explained later.

On the other hand, when the detection result obtained in step S220 indicates affirmation (“YES” in step S220), i.e., the irradiation parameters have been changed, the operation flow goes to step S230.

In step S230, the processing section 10 compares the previous irradiation parameters with the new irradiation parameters currently fetched from the memory section 11. In step S230, the processing section 10 determines that the current light source currently detected in the currently captured image data (current frame) is the previous light source previously detected in the previously captured image data (previous frame) when the current light source is present within a predetermined area in the currently captured image data in consideration with the position of the own vehicle and a movement of the previous light source. The processing section 10 compares the luminance of the current light source with the luminance of the previous light source. The operation flow goes to step S240.

In step S240, the processing section 10 detects whether or not the luminance of the detected light source is changed after the irradiation parameters are changed. In the process of step S240, the processing section 10 detects whether or not a difference in luminance between the light source previously detected in the previously captured image data (previous frame) and the same light source currently detected in the currently captured image data (current frame) exceeds a predetermined threshold value, where the predetermined threshold value is determined in advance on the basis of an estimated value of a change of luminance of a light source when corresponding irradiation parameters are changed.

When the detection result obtained in step S240 indicates affirmation (“YES” in step S240), i.e., the difference in luminance is generated in the detected light source, the operation flow goes to step S250. In step S250, the processing section 10 stores light source information into the memory section 11, where the light source information indicates that the detected light source is a reflector which does not a luminous object which emits no light. The operation flow goes to step S350.

On the other hand, when the detection result obtained in step S240 indicates negation (“NO” in step S240), i.e., no difference in luminance is generated in the detected light source, the operation flow goes to step S260 because there is a high probability that the detected light source is a vehicle light source. In step S260, the processing section 10 calculates various types of feature values of the detected light source as a vehicle light source, for example, a feature value of a stationary image level, a pair feature value, and a time series feature value.

The feature value of a stationary image level of the light source indicates a color and a shape of a light source. The pair feature value of the light source indicates a relationship between the light source and another light source which is present in a horizontal direction. The time series feature value of the light source indicates a traced result of the light source in the captured image data.

The above detected feature values of the detected light source are calculated on the basis of the comparison results with reference values (which are data regarding colors and shapes of light sources as comparative values) stored in the memory section 11. In particular, the time series feature value of the light source is calculated on the basis of a movement direction and a moving speed of the detected light source immediately when the detected light source is appeared in the captured image data.

The operation flow goes to step S270. In step S270, the processing section 10 calculates a probability value of the detected light source on the basis of the calculated feature values of the detected light source. The probability value of the detected light source indicates a probability that the detected light source is a vehicle light source. The probability value of the detected light source is obtained by calculating a weight average of each of the feature values. It is possible for the processing section 10 to use a map which indicates a relationship between each of the feature values previously described and a probability value of a light source.

The operation flow goes to step S280. In step S280, the processing section 10 compares the calculated probability value of the detected light source with the threshold value which has been determined in advance.

When the detection result obtained in step S280 indicates affirmation (“YES” in step S280), i.e., indicates that the calculated probability value is not less than the predetermined threshold value, the operation flow goes to step S290. In step S290, the processing section 10 stores the detection result that the detected light source is a vehicle light source such as a head lamp of a vehicle into the memory section 11.

On the other hand, when the detection result obtained in step S280 indicates negation (“NO” in step S280), i.e., indicates that the calculated probability value is less than the predetermined threshold value, the operation flow goes to step S300. In step S300, the processing section 10 stores the detection result into the memory section 11. This detection result indicates that the detected light source is a reflector not a luminous object, i.e. it emits no light.

The operation flow goes to step S350. In step S350, the processing section 10 detects whether or not a vehicle light source is detected in the captured image data. When the detection result obtained in step S350 indicates affirmation (“YES” in step S350), i.e., indicates that a vehicle light source is detected, the operation flow goes to step S360. In step S360, the processing section 10 generates and transmits an instruction to the light beam control section 30 in order to switch to a low beam of the head lamps HL1 and HL2 of the own vehicle.

On the other hand, when the detection result obtained in step S350 indicates negation (“NO” in step S350), i.e., indicates that a vehicle light source is not detected, the operation flow goes to step S370. In step S370, the processing section 10 generates and transmits an instruction to the light beam control section 30 in order to switch the head lamps of the own vehicle to a high beam. The processing section 10 completes the light beam control process shown in FIG. 2.

In the light beam control system 1 having the structure previously descried, the processing section 10 changes the irradiation parameters which indicate an irradiation range or a luminance of a light beam of the light sources such as the head lamps HL1 and HL2 of the own vehicle, where the light beam of the head lamps HL1 and HL2 is irradiated toward a light source detected in the captured image data. The processing section 10 detects whether or not a luminance of the detected light source is changed on the basis of the change of the irradiation parameter. Further, the processing section 10 decreases the probability value of the detected light source when the luminance is changed on the basis of the changed irradiation parameter as compared with the probability value of the detected light source when no luminance is changed. That is, there is a high probability that the detected light source having the decreased probability value does not a luminous object which emits no light. Further, the processing section 10 compares the calculated probability value of the detected light source with the predetermined threshold value. When the detection result indicates that the probability value of the detected light source is not less than the predetermined threshold value, the processing section 10 determines that the detected light source is a luminous object, for example, a head lamp of an oncoming vehicle which emits light.

In particular, the processing section 10 detects whether or not the change of the luminance intensity of the detected light source on the basis of the change of the irradiation parameter is not less than the reference value stored in the memory section 11. When the detection result indicates that the change of the luminance intensity of the detected light source is not less than the reference value stored in the memory section 11, the processing section 10 decreases the probability value of the detected light source, where the probability value indicates a probability that the detected light source is a luminous object which emits light. That is, when the probability value of the detected light source is decreased, the detected light source is not a luminous object which only reflects light and emits no light.

That is, the inventors of the present invention have paid attention to the following feature. When the irradiation parameters of the head lamps HL1 and HL2 of the own vehicle are changed, i.e., when the luminance of a light beam of the head lamps HL1 and HL2 of the own vehicle is changed, a luminance change of a luminous object which emits light (for example, a head lamp of an oncoming vehicle) is lower than a luminance change of a non-luminous object such as a reflector. Further, the processing section 10 changes a probability value of detected light source, which indicates a probability that the detected light source is a luminous object such as a head lamp of a vehicle, on the basis whether or not luminance of the detected light source is changed by more than the reference value stored in advance in the memory section 11 when the irradiation parameter is changed.

Accordingly, the light beam control device 1 according to the exemplary embodiment having the structure previously, described can quickly distinguish a reflector from a luminous object with high accuracy, where the reflector reflects the light beam of the head lamps HL1 and HL2 of the own vehicle, and the luminous object such as head lamps of an oncoming vehicle emits light. This makes it possible to detect a light source as a luminous object which emits light in captured image data with high accuracy.

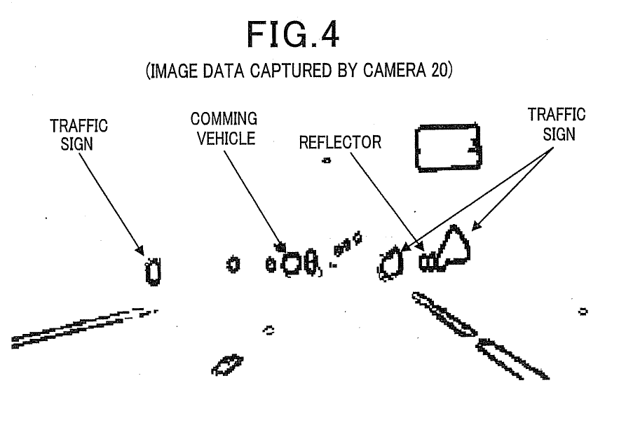

FIG. 4 is a view showing an example of captured image data (one frame) obtained by the camera 20 which is processed by the processing section 10 in the light beam control system 1 according to exemplary embodiment shown in FIG. 1.

In particular, when first type light sources (such as head lamps of an oncoming vehicle) are compared in size with second type light sources (such as traffic signs and reflectors), the first type light source have approximately the same size of the second type light sources in the captured image data shown in FIG. 4. In the captured image data shown in FIG. 4, the traffic signs and the reflectors are relatively close to the own vehicle, and on the other hand, the oncoming vehicle is further from the own vehicle than the traffic signs and the reflectors. In this case, because the traffic signs and the reflectors as the second type light sources do not emit any light, the luminance of each of the traffic signs and the reflectors is significantly changed when the irradiation parameters of the light beam of the head lamps of the own vehicle are changed. That is, in the case shown in FIG. 4 having a difficulty of distinguishing various types of light sources from each other, it is possible for the light beam control system 1 to quickly distinguish a luminous object such as head lamps of an oncoming vehicle which emit light from a non-luminous object such as traffic signs and reflectors which emit no light, with high accuracy, where the light beam control system 1 is comprised of the light emitting source detection device and the light beam control device.

The processing section 10 as a control section in the light beam control system 1 sets the probability value of a detected light source to a value which indicates a second type light source such as a traffic sign and a reflector which emit no light when the luminance of the detected light source is changed on the basis of a change of the irradiation parameters.

Further, the processing section 10 as the, control section in the light beam control system 1 determines that a detected light source is a second type light source such as a traffic sign and a reflector when a the luminance of the detected light source is changed on the basis of a change of the irradiation parameters. After the execution of the above determination process, it is possible to avoid the process which detects whether or not the detected light source is the first type light source such as head lamps of a vehicle which emit light. Therefore this makes it possible to reduce the load of the processing section 10.

Still further, the processing section 10 as the control section in the light beam control system 1 changes the irradiation range of the light beam of the head lamps of the own vehicle as the change of the irradiation parameter. In more detail, when changing the irradiation parameters, the processing section 10 changes a direction of an optical axis of the head lamps of the own vehicle.

Because it is possible to use available hardware devices in order to form the light beam control system 1 comprised of the processing section 10 as the light emitting source detection device and the light beam control section 30 as the light beam control device, this makes it possible to decrease the manufacturing cost of the light emitting source detection device and the light beam control device.

Still further, the processing section 10 obtains information regarding a curved road from the automotive navigation system 31 shown in FIG. 1 when the own vehicle just approaches the beginning of the curved road, and changes or adjusts the irradiation parameters on the basis of the obtained information regarding the curved road.

That is, in general there are many non-luminous objects such as reflectors on the beginning of a curve road. It is possible for the light beam control system 1 comprised of the light source detection device having the structure previously described to recognize luminous objects such as head lamps of a vehicle and non-luminous objects such as traffic signs and reflectors with high accuracy.

In particular, the processing section 10 as the light emitting source detection device changes the irradiation parameters of the head lamps of the own vehicle within one period of the process for controlling the light beam of the head lamps.

Still further, it is possible for the light beam control system 1 comprised of the light source detection device having the structure previously described to suppress influence of the light beam on the visual field of the driver of an oncoming vehicle as well as the driver of the own vehicle.

### (Other Modifications)

The concept of the light beam control system 1 comprised of the processing section 10 as the light emitting source detection device and the light beam control section 30 as the light beam control device according to the present invention is not limited by the exemplary embodiment previously described. It is possible to have various modifications.

For example, in order to change the irradiation parameters, the processing section 10 is configured to change the irradiation range of a light beam of the head lamps of the own vehicle. However, the concept of the present invention is not limited by this configuration of the processing section 10. It is possible for the processing section 10 to change an irradiation range or a luminous intensity of an infrared light beam as shown in FIG. 3B. In this case, the own vehicle is equipped with an infrared lamp IHL shown in FIG. 1 in addition to the head lamps HL1 and HL2 so that the infrared lamp IHL irradiates infrared light beam within the irradiation range of a light beam of the head lamps. When receiving the instruction signal transmitted from the processing section 10, the light beam control section 30 as the light beam control device adjusts the infrared beam of the infrared lamp IHL.

Because the light beam control system 1 having the above structure changes the irradiation range or the luminous intensity of infrared light beam of the infrared lamp IHL, it is possible for the light beam control system 1 comprised of the light emitting source detection device to suppress influence of the infrared light beam to the visual field of driver of an oncoming vehicle as well as the driver of the own vehicle.

As shown in FIG. 3C, in order to change the irradiation parameters, it is possible for the processing section 10 as the light emitting source detection device in the light beam control system 1 to change a luminance intensity of a light beam of the head lamps of the own vehicle. This structure makes it possible to reduce the manufacturing cost of the light beam control system 1 equipped with the processing section 10 as the light emitting source detection device and the light beam control section 30 as the light beam control device because it is possible to use available hardware devices.

As previously described, the processing section 10 as the light emitting source detection device changes the irradiation parameters of the head lamps of the own vehicle within one period of the process for controlling the light beam of the head lamps. The concept of the present invention is not limited by this. It is possible for the processing section 10 to change the irradiation parameters of the head lamps of the own vehicle within an optional period of time.

As previously described in detail, the processing section 10 corresponds to the light emitting source detection device used in the claims. The process in step S110 executed by the processing section 10 corresponds to a curved road information obtaining section used in the claims. The process in step S130 executed by the processing section 10 corresponds to an irradiation parameter change section used in the claims.

Further, the process in step S240 executed by the processing section 10 corresponds to a luminance change detection section used in the claims. The process in step S250 executed by the processing section 10 correspond to a probability value setting section used in the claims. The processes in step S250 executed by the processing section 10 correspond to a light emitting source detection section used in the claims. The processes in step S280 and step S290 executed by the processing section 10 correspond to a light emitting source detection section used in the claims.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A light emitting source detection device configured to detect a light emitting source in captured image data, comprising:
an irradiation parameter change section configured to change irradiation parameters to change an irradiation state of a light beam of a light source of an own vehicle toward a light source, which is present in front of the light emitting source detection device, when the light source is detected in captured image data;
a luminance change detection section configured to detect whether or not a luminance of the light source detected in the captured image data is changed when the irradiation parameter is changed;
a probability value setting section configured to decrease a probability value of the detected light source when the luminance of the detected light source is changed more than a probability value of the detected light source when the luminance of the detected light source is not changed; and
a light emitting source detection section configured to judge that the detected light source is a light emitting source as a luminous object which emits light when the probability value of the detected light source is not less than a predetermined threshold value.

2. The light emitting source detection device according to claim 1, wherein the probability value setting section sets the probability value of the detected light source to a value which indicates a non-luminous object which emits no light when the luminance of the detected light source is changed after the irradiation parameter change section changes the irradiation parameters.

3. The light emitting source detection device according to claim 1, wherein the irradiation parameter change section changes one of an irradiation range and a luminous intensity of an infrared light beam of an infrared lamp when the irradiation parameters are changed.

4. The light emitting source detection device according to claim 1, wherein the light emitting source detection device is mounted to the own vehicle, and the irradiation parameter change section changes a luminous intensity of a light beam of head lamps of the vehicle when the irradiation parameters are changed.

5. The light emitting source detection device according to claim 1, wherein the light emitting source detection device is mounted to the own vehicle, and the irradiation parameter change section changes an optical axis of head lamps of the vehicle when the irradiation parameters are changed.

6. The light emitting source detection device according to claim 1, further comprising a curved road information obtaining section configured to obtain information of a curved road when the own vehicle approaches a beginning of the curved road, and
the irradiation parameter change section changes the state of irradiation of the light beam of the light source when the curved road information obtaining section obtains the information of a curved road.

7. A light beam control system mounted to the own vehicle controlling an irradiation range of a light beam of head lamps of the own vehicle, comprising:
a vehicle light source detection device comprised of a light emitting source detection device according to claim 1; and
an irradiation range changing section configured to receive a detection result transmitted from the vehicle light source detection device, and when the detection result of the vehicle light source detection device indicates that the detected light source is a head lamp of a vehicle, the irradiation range changing section configured to change the irradiation range of the light beam of the head lamps of the own vehicle so that the irradiation range of the light beam of the head lamps of the own vehicle is out of the detected light source of the vehicle when the light source of the vehicle is detected.

8. A light emitting source detection device comprising:
a memory section configured to store one or more programs for executing the functions of the light emitting source detection device according to claim 1; and
a central processing unit configured to read the program stored in the memory section and execute the programs.
